(19) United States
(12) Patent Application Publication
(10) Pub. No.: US 2016/0147563 A1
(43) Pub. Date: May 26, 2016

(54) Method and Apparatus for Brought-In Device Communication Request Handling

(71) Applicant: Ford Global Technologies, LLC, Dearborn, MI (US)

(72) Inventors: Kwaku O. Prakah-Asante, Commerce Township, MI (US); Hsin-hsiang Yang, Ann Arbor, MI (US); Doron M. Elliott, Detroit, MI (US); Gary Steven Strumolo, Canton, MI (US)

(21) Appl. No.: 14/551,668

(22) Filed: Nov. 24, 2014

(51) Int. Cl. G06F 9/48; G06F 9/54

(52) U.S. Cl. CPC G06F 9/4818; G06F 9/546

(57) ABSTRACT

A system includes a processor configured to receive an incoming message request identifying a requesting application and requested user interface. The processor is also configured to determine an incoming message priority value. The processor is further configured to determine a message type. Also, the processor is configured to determine a driver attention demand value and provide access to the requested user interface when the priority value, message type, and driver attention demand value match parameters defined for the requested user interface.

### TECHNICAL FIELD

The illustrative embodiments generally relate to a method and apparatus for brought-in device communication and request handling.

### BACKGROUND

Modern vehicles come equipped with a variety of uni- and bi-directional data and communication interfaces available for interfacing with occupant brought-in devices. From wireless formats such as, but not limited to, BLUETOOTH or WiFi, to wired formats such as, but not limited to, AUX ports and on-board data bus (ODB) ports, passengers and drivers can utilize a number of options to create a communication connection between a brought-in device (e.g., without limitation, wearables, smart phones, personal computers, tablets, dongles, etc.) and a vehicle computing system.

Applications and processes running on brought-in devices may request utilization of vehicle resources as well, especially when it comes to interacting with a vehicle occupant. Messages may be sent through visual or audible outputs, and touch-sensitive screens and microphones can be used to obtain user feedback.

### SUMMARY

In a first illustrative embodiment, a system includes a processor configured to receive an incoming message request identifying a requesting application and requested user interface. The processor is also configured to determine an incoming message priority value. The processor is further configured to determine a message type. Also, the processor is configured to determine a driver attention demand value and provide access to the requested user interface when the priority value, message type, and driver attention demand value match parameters defined for the requested user interface.

In a second illustrative embodiment, a system includes a processor configured to receive a message request, identifying a vehicle interface. The processor is also configured to determine a message priority and message type. Further, the processor is configured to determine driver attention demand. The processor is additionally configured to set parameters, based on the driver attention demand, for the vehicle interface, defining message priorities and message types required for use permission and deliver a message included in the message request via the vehicle interface when the parameters set for use permission match the determined message priority and type.

In a third illustrative embodiment, a computer-implemented method includes receiving a message request identifying a vehicle interface. The method also includes determining, via a vehicle-computer, a message priority and message type. Further, the method includes determining driver attention demand. The method also includes setting parameters, based on the driver attention demand, for the vehicle interface, defining message priorities and message types required for use permission and delivering a message included in the message request via the vehicle interface when the parameters set for use permission match the determined message priority and type.

### BRIEF DESCRIPTION OF THE DRAWINGS

FIG. 1 shows an illustrative vehicle computing system;

FIG. 2 shows an illustrative brought-in device running multiple application types;

FIG. 3 shows an illustrative process for incoming message handling;

FIGS. 4A-4C shows illustrative processes for varied message authorizations; and

FIG. 5 shows an illustrative example of a user interface (UI) authorization process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

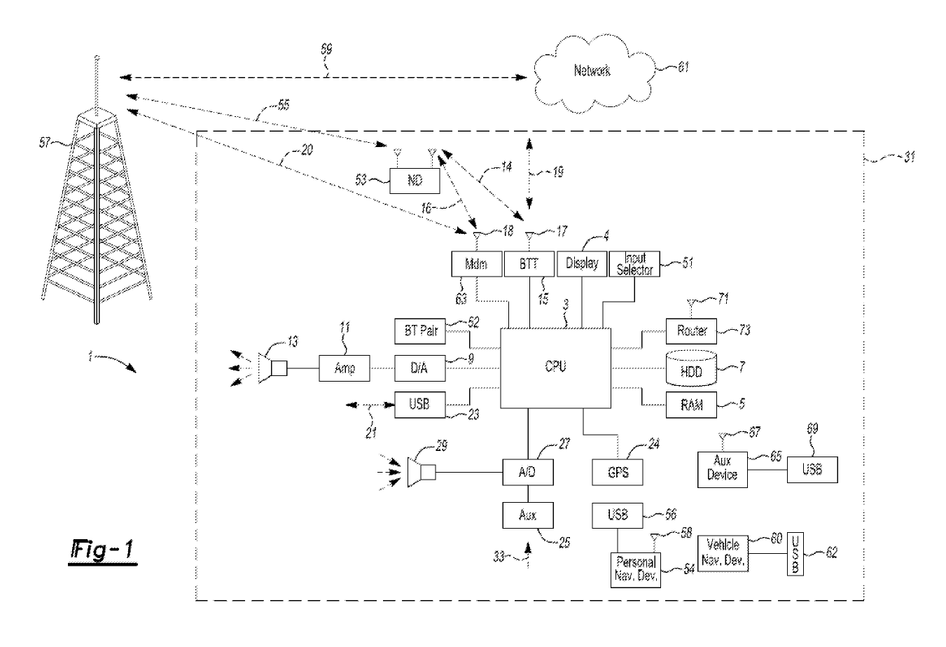

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

Telematics and vehicles connectivity has increased customer expectations and renewed competition for feature development within the vehicle cabin interior. Consequently, it is important to provide relevant connectivity and telematics information to a driver. Much of this content, however, can come from sources largely beyond the control of the OEM, such as applications running on smartphones, wearables, personal computers, tablets and other devices interfacing with a vehicle. By establishing rules in accordance with or similar to those modeled by the illustrative embodiments, automotive OEMs can exercise some measure of control over the content delivered in-cabin.

While the influx of smartphones to the consumer market has led the way for brought-in devices that can connect with vehicles, wearable device exposure is also steadily increasing. Brought-in systems range anywhere from $40 to over $500 and customers frequently seek to connect multiple devices to a vehicle. Of course, this results in multiple devices that potentially all seek to utilize vehicle inputs and outputs.

Many companies are developing applications that interact with in-vehicle displays and audio outputs to connect with and interface with a vehicle occupant. With a potential multitude of brought-in devices all requesting driver attention, the illustrative embodiments provide useful methodology for managing incoming connection requests. They provide an approach to coordinate connectivity requests for utilization of vehicle resources, typically output-type resources. The illustrative embodiments utilize combinations of consideration of requesting application identification/permissions, type of interface requested, importance of incoming information delivery and driver attention demand states to determine if a requested user interface (UI) will be provided or denied for utilization in delivering an incoming message.

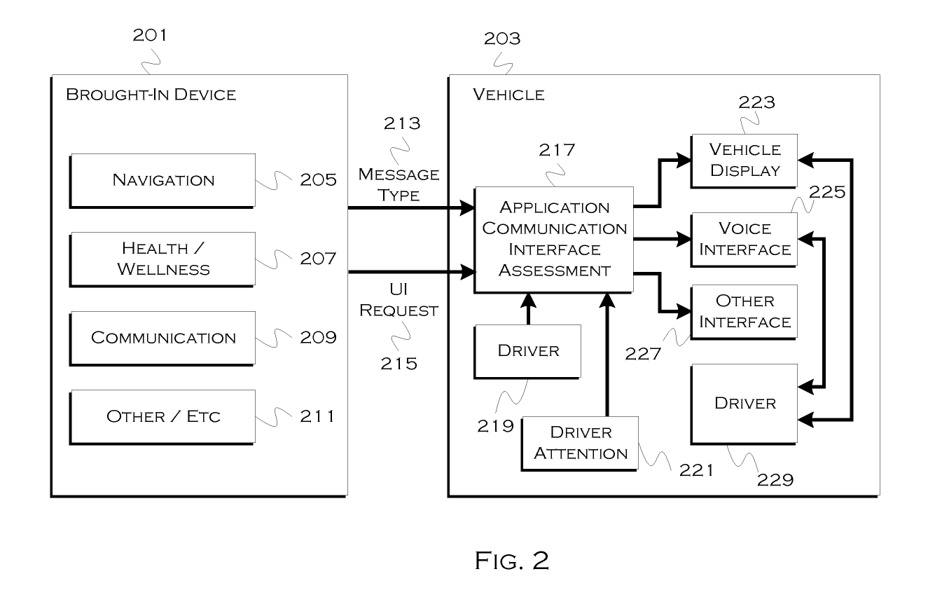

FIG. 2 shows an illustrative brought-in device 201 running multiple application types. On the vehicle 203 side of the system, in this illustrative example, an application communication interface assessment process 217 is run, which may apply artificial intelligence, fuzzy decision making, and/or rule based systems to determine if communication is permitted and what communication interface to provide.

In operational mode, the application communication interface assessment process may obtain inputs from both the brought-in device and vehicle sub-systems. The device will provide, in this example, a coded message identifying the requesting application (with at least a minimum amount of data needed to make the appropriate assessments regarding the requesting application) 213 and identification of a requested user interface 215. Systems for gauging application message importance 219 and driver attention demand loads 221 are provided as part of vehicle sub-systems, in this example.

The application message importance may be, for example, a database of ranking determined by an OEM about the value of messages sent by a requesting application. For example, without limitation, navigation messages may have higher value than advertisements, and may be provided with higher priorities. Granulation of the importance of messages can be as fine as desired, even navigation messages may be divided into messages of varying priority (e.g., without limitation, a message to “turn in 0.5 miles” may be given higher priority than a message to “stay on current road for 100 miles”). The database can define the rules for message priority from particular applications, from particular application types, or can even provide a list of permitted priorities defined by the application itself, for trusted applications. That is, if the OEM trusts the application to work within a set of guidelines for prioritization of messages, the entry for that application may merely define what priorities can be set by the application, as opposed to defining what priority the message from the application should receive. Driver attention demand can be measured utilizing known driver-demand measuring techniques, which frequently involve considerations of the vehicle, driver, exterior environment and interior cabin.

Based on a synergistic evaluation of inputs, the various applications 205, 207, 209, 211 can be provided with access to, or prevented from accessing, vehicle interfaces 223, 225, 227. As can be seen from FIG. 2, a number of exemplary application types include navigation applications 205, health and wellness applications 207, phone and text applications 209 and other applications not categorized here 211. The interfaces commonly requested include vehicle display interfaces 223, voice interfaces 225 and other interfaces not categorized here 227. Each interface provides an opportunity to interact with a vehicle driver 229 or occupant, and control of the messages to those interfaces is provided by the evaluation of the inputs described herein and similar inputs.

A number of alternative configurations is also possible for the system, and a few exemplary alternatives will also be described. For example, the driver attention demand process could reside on the brought-in device. If the brought-in device had a driver attention demand application capable of accessing appropriate vehicle and/or remote resources in order to make a driver attention demand evaluation, then the device itself might provide this information to the application communication interface assessment process running in the vehicle.

In another non-limiting example, the application message importance database may also be provided on the mobile device, and can be updated periodically for various applications, or can be updated, for example, when an application is updated. As previously noted, certain trusted applications may be permitted to assign their own priorities to outgoing messages, provided the applications act in accordance with manufacturer rules for prioritizing messages. In these cases, the database may provide a set of prioritization guidelines, for use in ensuring that a selected priority is at least permissible for a given application (e.g., without limitation, it is unlikely that an advertisement application would be given to rank a message as “high” priority). The guidelines, as well as the generalized rules for priority ranking, may also be context dependent, so, for example, an advertising application may be given the ability to use a “high” priority if and only if a certain context applies (e.g., the user is already stopped at the location for which the advertisement is provided, or some other reasonable time when immediate message delivery might be highly desirable for a user).

Any and all needed databases and decision making processes can also be provided remotely in the cloud, and may be accessed through a wireless connection through a brought-in device with cloud access, or, for example, through a vehicle-based modem. Databases that reside onboard a vehicle or mobile phone can be updated when connections are available, at periodic intervals or any other appropriate time. Rules for determining driver attention demand and/or driver profiles used in gauging attention demand may also be updated at an appropriate time.

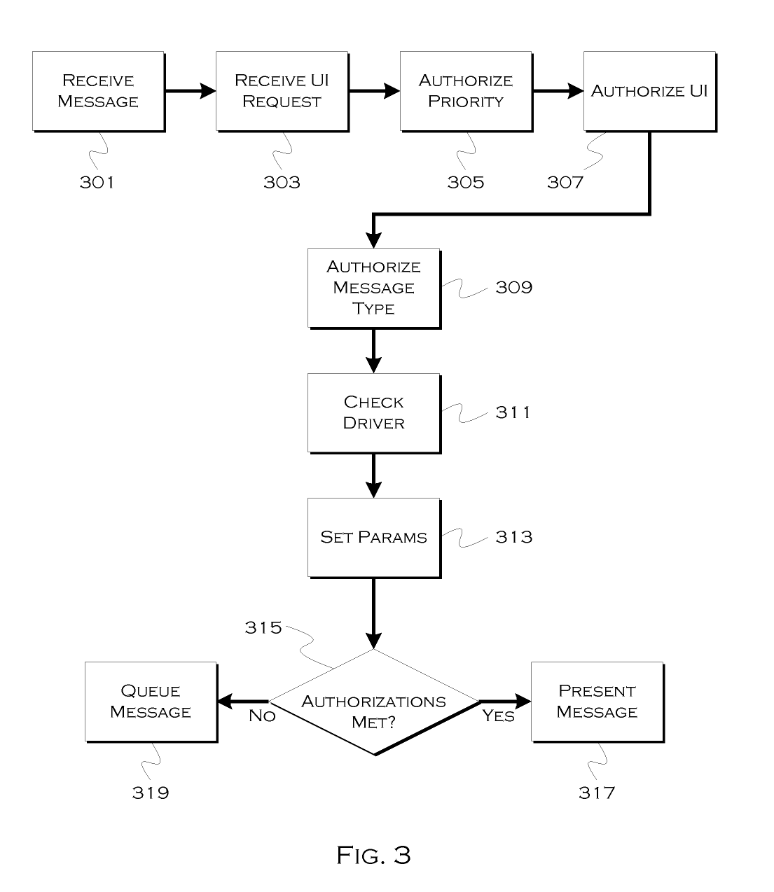

FIG. 3 shows an illustrative process for incoming message handling. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

When a brought-in device seeks to utilize a message delivery system in the vehicle (e.g., without limitation, vehicle display, speakers, etc.), the process typically will receive the message 301 or a message request from a requesting application. This request will also typically identify a requesting application, or at least a requesting application type (if prioritization based on categorization is employed). In addition to the message or information about the message/requesting application, the process will receive a UI request 303 identifying which user interface is preferred. In some examples, a secondary UI may also be requested, if a primary UI is not available based on the results of the decision making For example, an advertisement may not be permitted to be displayed at a certain time, but it may be acceptable to play the advertisement through vehicle audio. If secondary UIs are requested, separate determinations can be made for those UIs if use of a preferred UI is denied.

In this example, a number of possible considerations go into determining which UI is permissible for which messages at which times. One consideration is message priority 305. As previously noted, applications may have a default priority or priorities assigned thereto. When only one priority is assigned, all message requests from that application will receive the same priority. Some applications may be given access to higher priorities for certain message types or under certain conditions. Accordingly, a message prioritization process can utilize information about the requesting application, in conjunction with a message type and/or other data useful in determining if an “exception” case is present, and approve a priority for a message 305. The message may also have a requested priority included therewith, in which case the process can determine the appropriateness of the requested priority before proceeding, and assign an appropriate priority if the requested priority is inappropriate. In one non-limiting model, messages are assigned at least three priorities (low—e.g., advertisements, non-time sensitive messages; medium—e.g., application upgrade availability, time sensitive advertisements, voicemail notifications, navigation detours to points of interest (POIs); high—e.g., health messages requiring immediate action, incoming phone calls, navigation directions). Which messages, message types, applications and application types are provided with which priorities is a matter of design choice, and any variations are included within the scope of the invention.

The process may also consider which UI is requested by the application 307. Based on a list of approved UIs for a given application, it can be determined whether the application is requesting a UI that is even available for the given application (availability of the actual UI will be determined at a later time, in this illustrative example). If the requested UI is not available, the process may assign the “best” UI that is allowed for an application. For example, if an application requested use of both sound and display, but was only permitted to use either sound or display, the application may provide “display” as a preferred UI, especially if access to display was limited enough that messages appearing there were likely to catch a driver's attention.

The process may also consider an application type or message type 309 (since some applications may deliver messages of varied type). A number of message types can be assigned based on categorization of message types, and values provided by the application can be checked, or values can be assigned based on a providing application and/or message content. Developers can be provided with guidelines as to what to include in messages to have the messages categorized as certain types, if message-type categorization is utilized based on message content. In an alternative example, the application will identify the message type included with the request. In still another example, the message type will be assigned based on, for example, the requesting application type.

Next, the process may consider a current driver attention demand level 311. This level can be determined using known techniques and can be used to evaluate what level of attention is required by the driver for performing current driving actions. Based on a demand level, only certain vehicle outputs may be accessible. For example, in bad weather and heavy traffic, access to a vehicle display may be considered to be too distracting, and may be limited for all but the most urgent messages (which could include, for example, immediate navigation decisions, hazardous condition warnings, incoming phone calls from priority parties, etc.). Based on the level of available driver attention, utilization parameters for each type of UI may be set 313.

If an application meets all parameters for a requested UI 315, or a requested secondary UI, the process may proceed to present the requested message via the UI 317. On the other hand, if the message cannot use the requested UI and no suitable secondary UI is available, the message may be queued 319 until such time as the requested UI is available. Of course, the message may also become irrelevant at some point prior to delivery, and can be removed from the queue when appropriate if such an instance occurs.

In one generalized exemplary model, the decision making process for a given message can be described as {if message_type is A, UI_request is B, importance_value is C, and Driver_Attention is D, then available_UIs is/are N}. In this example, the rules for use of certain UI's are predefined based on the incoming consideration values, and the UI requested would be checked against the available UIs to determine if it fell within the permissible UI scope. In another example the rules for UI use may be set based on a current driver attention level and a requested UI can be checked against the dynamic settings to see if current requirements for use of a requested UI are met.

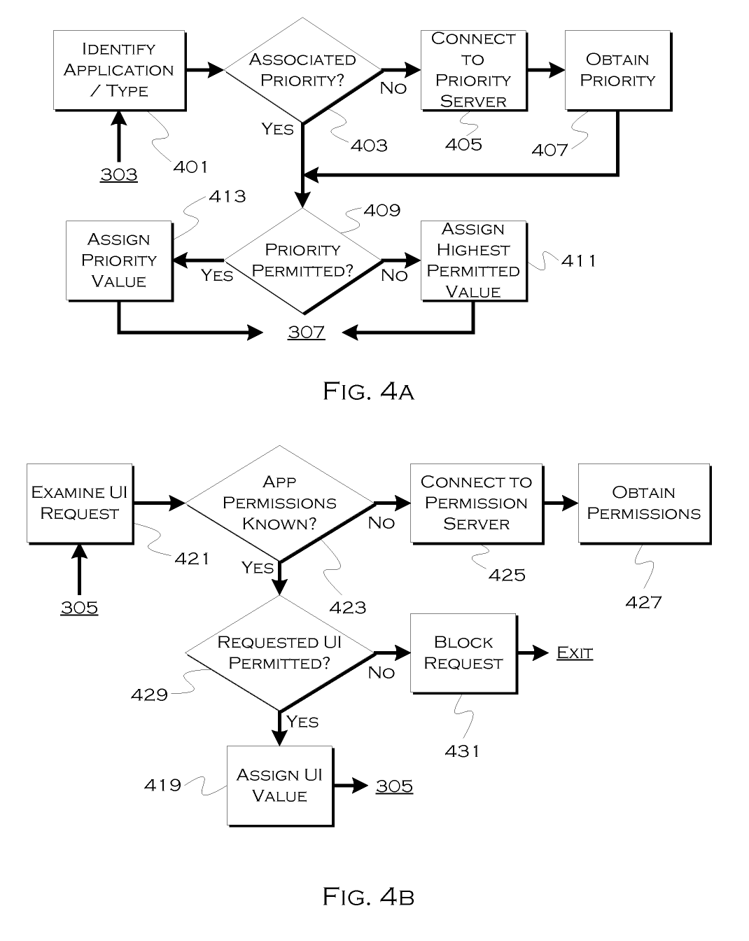

FIGS. 4A-4C show illustrative processes for varied message authorizations. With respect to the illustrative embodiments described in these figures, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the methods are completed. In another example, to the extent appropriate, firmware acting in accordance with a preconfigured processor may cause the processor to act as a special purpose processor provided for the purpose of performing the methods or reasonable variations thereof.

FIG. 4A shows an illustrative process for identifying a message priority. In this example, the process receives data allowing for identification of a specific application or an application type 401. Once the application or application type has been identified, the process can determine if there is an associated priority with the message from the application 403. This could be an assigned priority provided by the application, or, for example, could be a priority associated based on a local database entry and assigned by the local process. If there is no assigned priority with the message or provided in the local database, the process can connect to a remote priority server 405. From the server, the process can obtain an appropriate priority 407 based on, for example, message type, message contents, application type, application name, etc.

Once the priority has been obtained or assigned, the process may determine if the priority is permitted 409. Of course, if the priority is assigned by the local process or obtained from the remote database, the priority is likely permitted. On the other hand, if the priority is assigned by the requesting application, the permissibility of the assigned priority may need to be double-checked. If the assigned priority is not permissible (based on, for example, comparison to a database of permissible assigned priorities), the process will assign an appropriate priority (through, for example, the assignment steps above) 411. Once a permissible priority is present, the process assigns a value corresponding to the priority 413 (which could also be assigned as part of assigning the priority and/or provided as the priority itself from the requesting application) and then proceeds.

FIG. 4B shows an illustrative example of a user interface request verification process. Not all applications and/or application types are permitted to utilize all interfaces. Some applications may be limited in user interface use based on content of delivered messages. For example, without limitation, an advertiser may be prohibited from using a visual interface unless a coupon is being presented to a driver. Thus, any request to utilize the visual interface to display an advertisement without a coupon would be inappropriate.

In this illustrative process, the user interface (UI) request is examined 421. The process may check a local database of application permissions to see if a) the database exists and b) the database defines permissions for the requesting application, application type, message type, etc. In some cases, message contents may be usable to identify a message-type, which could be sufficient to authorize a user interface use even if permissions for a given application are not known locally.

In this example, if the permissions for the application or application type are not known or locally available 423, the process connects to a permission server 425 that contains all the permissions for all approved applications. The appropriate permissions for user interface use based on application, application type, message type, message contents, etc. are obtained 427 and, once the appropriate permissions are known, the process can check to see if the requested user interface is proper 429. Again, the appropriateness of the interface could be based on requesting application, requesting application type, message type, message contents, etc. If an impermissible user interface is requested 429, the process may block the request 431.

As previously noted, blocking the request may not terminate the message delivery. For example, if a secondary interface is requested, the verification process may be repeated for the secondary interface. If a permissible user interface is requested 429, the process may assign a user interface value (or otherwise identify the user interface in a manner usable by the eventual use permission/denial determination). Again, the “value” associated with the user interface could be assigned from the inception and used to complete the rest of the user interface verification process based on the value as a proxy for the user interface identification.

FIG. 4C shows an illustrative example of a message type verification/assignment process. In this illustrative example, the process examines an incoming message type 441 (if provided by the requesting application). If the message type is not available, the process may attempt to categorize the message based on a local database providing message types for various identified applications. If the message type cannot be assigned or is not locally known or identifiable, the process may connect to a remote server that provides message type identification for permitted applications 445. An application ID, in this case, is provided to the server 447 and a corresponding message type is received 449. In other examples, the message itself may be provided (if, for example, the message type is determined based on message contents, or if message contents are needed to decide between a plurality of types for a given application). In at least one instance, a given application has a plurality of types of messages provided in conjunction therewith, and message contents may be used to determine which of the plurality of types corresponds to a given message. The requesting application may also provide a suggested message type that can be cross checked against permissible types.

The process may also check to see if the message type is permitted. Again, if the message type has been assigned by the local process, then the type is probably permitted for the requesting application (i.e., the local process is unlikely to identify a shoe advertisement as a navigation type message). But, if the requesting application provided the message type, the process may need to ensure that the provided type is permissible for the requesting application (since some data providers may be encouraged to “cheat” by misidentifying messages if they know a certain message type has a higher likelihood of being displayed). If the message type is impermissible 451, the process will assign a permitted message type 453, which may take the form of the process previously described for assigning a message type (i.e., check a local database and/or check a remote database). Again, once the type is permissible, the process assigns a type value associated with the assigned type 455.

In the illustrative examples, types/priorities/user interfaces are defined using words and values are utilized for a determination process, but the values could be easily also utilized to define the types/priorities/user interfaces as well, skipping the “assign value” steps. Alternatively, the equation could search for specific words instead of values when deciding whether or not to permit use of a particular user interface. The use of words and the corresponding values is illustrative in nature only, and not intended to limit the scope of the claimed subject matter.

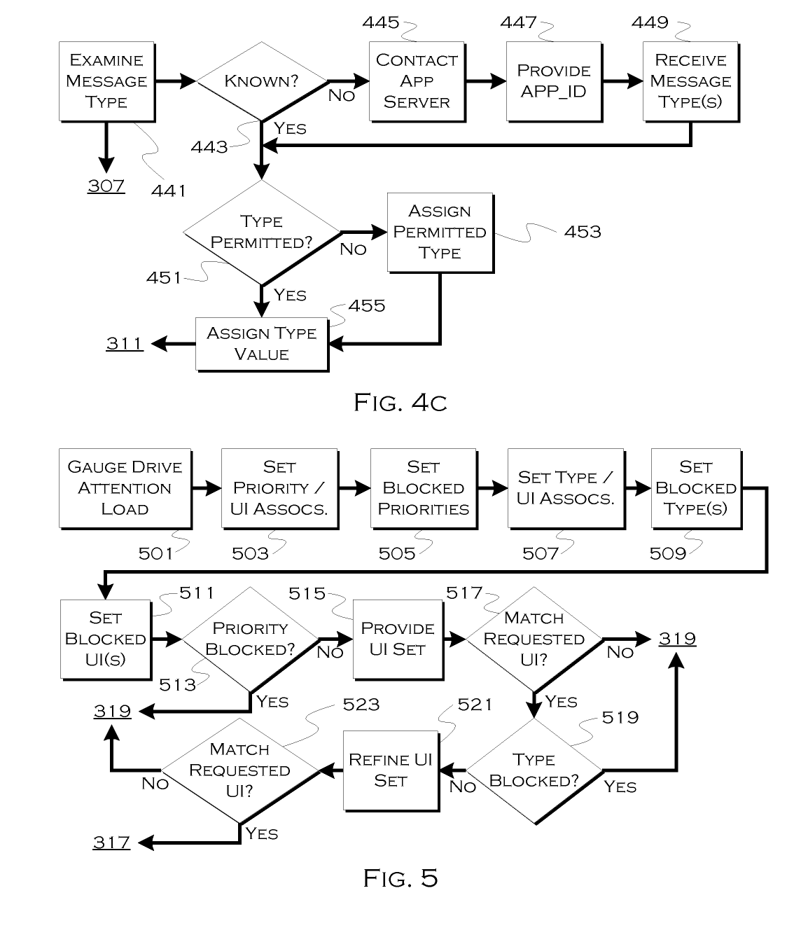

FIG. 5 shows an illustrative example of a user interface (UI) authorization process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, driver attention load is used to set the parameters (in terms of message type and message priority) for vehicle/user interface utilization. That is, for example, when driver attention demand is high, only select message types and/or message priorities may have unfettered access to vehicle interfaces, whereas when driver attention demand is low, the requirements for interface utilization may be relaxed. Of course, any suitable model for defining which messages/applications/priorities can access which interfaces at what times and based on what conditions may be utilized.

In this example, the driver attention load (or driver attention demand) is gauged based on known techniques. Typically, for example, when the driver is turning, in traffic, driving in weather, etc. the driver attention demand may be high, whereas when the driving is driving straight, in no traffic, in clear weather, etc., the driver attention demand may be low. Based on the observed level of driver attention demand, the process may set the required message priorities for use of each of the vehicle interfaces 503. The process may also block certain priorities from use of any interfaces while demand is above a certain level 505 (e.g., high driver attention demand may result in a blockage from all interfaces of low priority messages, regardless of type).

In a similar manner, based on the driver attention demand, the process may set the message type(s) required for use of a given interface under current conditions 507. Again, based on the current driving demand, the process may block certain message types 509 (e.g., no advertisements during high driver demand situations). The process may further set blocked interfaces if desired, such that no message of any kind can utilize certain interfaces when demand is high 511.

In this example, an incoming message has been received and has a certain message type and priority associated therewith. The process will first check to see if the message priority is blocked, based on current driver demand 513. If the message priority is not permitted on any interface based on current conditions, the process may queue the message for later delivery 319. If the priority does not result in a block, then the process will provide a set of user interfaces approved for that priority 515, based on the settings previously performed. In some examples, a fixed set of rules may be established covering all possible iterations of driver demand levels (presumably on a finite scale), message types, user interface requests and message priorities, but in this example the rules for usage of a UI are defined dynamically based on a current driver attention load (although still based on a predefined model).

If a permissible UI provided by the process matches the requested UI requested by the requesting application for message delivery 517, the process may then proceed to determine if the message type also meets the requirements 519. If the requested UI does not match a permitted UI for the message priority, the process may queue the message.

The process next checks to see if the requesting message type is currently blocked from any UI interface use. For example, an advertisement may typically only be permitted to use audible outputs, unless a coupon is provided. The advertisement may also typically be given a low priority, unless a vehicle is within 0.1 miles of a corresponding merchant location, in which case it receives a high priority (these are illustrative examples only). So, in a high driver demand situation, only messages of high importance having types (emergency, medical, health, permitted caller list) may be allowed to be delivered. Further, all advertising type messages may be blocked. The advertising message may meet the priority requirements for delivery but would be blocked based on message type at step 519. This allows for the system to consider both a message priority and type before delivering the message.

If the message type is not blocked 519, the process may refine the available user interface set for the message type 521. For example, messages of high priority may be given access to all interfaces, but advertising messages may only be given audio access unless they include a coupon. If advertising messages are not blocked, and a message is received within 0.1 miles of a merchant, but includes no coupon, the message would receive access to all UI types based on the priority, but then have the available UI set refined to exclude the display based on the message type advertisement_no_coupon. If the advertisement (or other request) matches the remaining available user interface types following any refinement based on message type 523, the process can proceed to output the message 317. Otherwise, again, the message can be queued 319.

The illustrative embodiments provide methods and apparatuses to intelligently manage the provision of driver interaction access for telematics and connectivity information based on expanded context including message types and message priorities, which can also be based on message contents, application names, and application types. Through use of the illustrative embodiments and the like, control of brought-in device messaging through vehicle systems can be obtained.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive an incoming message request identifying a requesting application and requested user interface;
determine an incoming message priority value;
determine a message type;
determine a driver attention demand value; and
provide access to the requested user interface when the priority value, message type, and driver attention demand value match parameters defined for the requested user interface.

2. The system of claim 1, wherein the requesting application is identified by name.

3. The system of claim 1, wherein the requesting application is identified by type.

4. The system of claim 1, wherein the incoming message priority value is provided by the requesting application and the processor is configured to verify permissibility of the incoming message priority value as part of the determination of the incoming message priority value.

5. The system of claim 1, wherein the incoming message priority value is provided based on incoming message contents.

6. The system of claim 1, wherein the incoming message priority value is provided based on incoming message type.

7. The system of claim 1, wherein the incoming message priority value is provided based on a requesting application type.

8. The system of claim 1, wherein the message type is defined based on message contents.

9. The system of claim 1, wherein the message type is defined by the requesting application and the processor is configured to verify permissibility of the message type as part of the determination of the message type.

10. The system of claim 1, wherein the message type is defined based on a requesting application type.

11. A system comprising:
a processor configured to:
receive a message request identifying a vehicle interface;
determine a message priority and message type;
determine driver attention demand;
set parameters, based on the driver attention demand, for the vehicle interface, defining message priorities and message types required for use permission; and
deliver a message included in the message request via the vehicle interface when the parameters set for use permission match the determined message priority and type.

12. The system of claim 11, wherein the message priority is determined based on the message type.

13. The system of claim 11, wherein the message request includes requesting application identification, and the message priority is determined based on a requesting application type, obtainable using the requesting application identification.

14. The system of claim 11, wherein the message request includes requesting application identification, and the message priority is determined based on a requesting application name, obtainable using the requesting application identification.

15. The system of claim 11, wherein the message request includes requesting application identification, and the message type is determined based on a requesting application type, obtainable using the requesting application identification.

16. The system of claim 11, wherein the message request includes requesting application identification, and the message type is determined based on a requesting application name, obtainable using the requesting application identification.

17. The system of claim 11, wherein the message request includes requesting application identification, and wherein the processor is configured to retrieve a message priority from a database including the requesting application identification and a priority assigned to messages therefrom.

18. The system of claim 17, wherein the requesting application identification has a plurality of priorities assigned thereto, based on message content guidelines, and wherein the processor is configured to determine the message priority by comparison of message content included with the message request with the message content guidelines corresponding to each of the plurality of priorities.

19. The system of claim 11, wherein the message request includes requesting application identification, and wherein the processor is configured to retrieve a message type from a database including the requesting application identification and a type assigned to messages therefrom.

20. A computer-implemented method comprising:
receiving a message request identifying a vehicle interface;
determining, via a vehicle-computer, a message priority and message type;
determining driver attention demand;
setting parameters, based on the driver attention demand, for the vehicle interface, defining message priorities and message types required for use permission; and
delivering a message included in the message request via the vehicle interface when the parameters set for use permission match the determined message priority and type.
